(19) United States
(12) Patent Application Publication
(10) Pub. No.: US 2010/0225502 A1
(43) Pub. Date: Sep. 9, 2010

(54) Colored LED traffic light display

(76) Inventor: Mohamed Roshdy Elsheemy, Akron, OH (US)

Correspondence Address: Mohamed R.Elsheemy, P.O. Box 1424, Akron, OH, 44309, US

(21) Appl. No.: 12/381,168

(22) Filed: Mar. 9, 2009

(51) Int. Cl. G08G 1/095; G09G 3/32

(52) U.S. Cl. 340/908; 345/83

(57) ABSTRACT

A programmable multi colored Light Emitting Diods (LEDs) rectangular display (panel) to replace the conventional traffic lights, the conventional traffic lights are generally vertically arranged consumes relatively alot of power and embedded into a bulky housing, the red light on top of the yellow light and the yellow light on top of the green light, the red light represents traffic must stop at an intersection, yellow light represents caution and green light represents traffic may pass, while in the new embodiment of the present invention a single rectangular LED display will provide the three traffic signal lights on the same area of the display consecutively,one after the other, in order to achieve this goal, the shapes of the three signal lights and the shapes of the arrow signal lights must be easily distinguishable for the color blind drivers.

Therefore the new invention provides a method and a system of updating the conventional traffic lights to have a less bulky, less power consumption and less expensive programmable LED traffic light display.

### FIELD OF THE INVENTION

The present invention relates to the field of traffic lights and more particularly,to LIGHT EMITTING DIODS (LEDs) traffic light.

### REFERENCES

### U.S. Patent Documents

U.S. Pat. No. 3,863,207 January 1975 Galella
U.S. Pat. No. 3,983,532 September 1976 Hayes
U.S. Pat. No. 4,271,408 June 1981 Teshima et al.
U.S. Pat. No. 4,839,647 June 1989 Patterson
U.S. Pat. No. 4,857,920 August 1989 Kataoka et al.
U.S. Pat. No. 5,136,287 August 1992 Borenstein
U.S. Pat. No. 6,054,932 April 2000 gartner et al.
U.S. Pat. No. 3,593,445 July 1971 Gant
U.S. Pat. No. 3,618,005 November 1971 Jensen
U.S. Pat. No. 5,014,052 May 1991 obeck
U.S. Pat. No. 5,150,116 September 1992 West
U.S. Pat. No. 5,898,381 April 1999 Gartner et al.
U.S. Pat. No. 5,990,802 November 1999 Maskeny
U.S. Pat. No. 6,064,318 May 2000 Kirchner, III et al.
U.S. Pat. No. 6,175,313 January 2001 Berezovsky
U.S. Pat. No. 6,317,058 November 2001 Lemelson et al.
U.S. Pat. No. 6,326,903 December 2001 Gross et al.
U.S. Pat. No. 6,331,824 December 2001 Firestone
U.S. Pat. No. 6,552,668 April 2003 Berezovsky
U.S. Pat. No. 6,710,722 March 2004 Lee
U.S. Pat. No. 7,167,106 January 2007 Haase
2002/0140604 October 2002 Doi
2003/0060158 March 2003 Riganati et al.
2005/0237224 October 2005 Gotfried
U.S. Pat. No. 7,443,315 October 2008 Lo

### Foreign Patent Documents

U.S. Pat. No. 9,901,803 January, 2001 BR
U.S. Pat. No. 2,240,171 November, 1996 CN
U.S. Pat. No. 2,296,121 June, 1996 GB
2001074148 August, 2001 KR
2003037703 May, 2003 KR
WO 2004/038685 May, 2004 WO
WO 2005/093684 October, 2005 WO
WO 2005/106823 November, 2005 WO

### BACKGROUND OF THE INVENTION

The conventional traffic lights usually arranged vertically with a housing comprising three or more rounds of signal lights, the red signal light on top of the yellow signal light and the yellow signal light on top of the green signal light, also the arrow signal lights arranged vertically, the yellow arrow on top of the green arrow,

generally the conventional traffic lights uses incandescent bulbs which consume alot of power and require periodic replacement.

Recently, the Light Emitting Diods (LEDs) signal lights started to replace the incandescent bulbs and still arranged vertically adopting the conventional way embedded into the bulky housing, the red LED round on top of the yellow LED round and the yellow LED round on top of the green LED round.

The red light signifying traffic must stop at an intersection, the yellow light signifying traffic will soon comes to a stop,the green light signifying traffic can pass through an intersection,

the green arrow signifying the turning,the yellow arrow signifying the turning will end soon.

The vertical arrangement of the light rounds is used to help the color blind drivers to distinguish one color light from the other.

Furthermore, Light Emitting Diods (LEDs) panels are in use everyday in many applications such as advertising texts and advertising videos, multi color LEDs are suitable for programmable panels to display colored texts or colored videos, generally, the red LEDs, the green LEDs and the blue LEDs are the most common LEDs used in the multi color LED panels (displays), therefore, the multi color LEDs displays are very suitable for the use as traffic signal lights while the three desired color lights; red, yellow and green are displayed on the same screen area of the display consecutively.

In this approach the shapes of the traffic signal lights will be a significant tool to help the color blind drivers to distinguish one color light from the other, therefore the use of a programmable LED display will provide a method and a system to display the desired traffic lights with the desired patterns, shapes and texts during the desired periods of time.

Furthermore, the screen area of the display (panel) will be covered by a matrix of LED clusters arranged tightly, each cluster will contain at least three LEDs; a red, a green and a blue or a yellow LED.

Furthermore, LED displays consume relatively low power, cost less and maintain less problems associated with the conventional traffic signal lights, also the LED displays provide high efficient color lights with great visibility in all weather circumstances.

### SUMMARY OF THE INVENTION

A multi color Light Emitting Diods (LEDs) display (panel) has a rectangular shape preferable (12×9) inches comprising a matrix of LED clusters tightly arranged, each cluster contains at least three different colored LEDs, preferably green, red and blue or yellow the display is controlled by a processor or a traffic computer to display the traffic signal lights consecutively, the LEDs emit the desired colored light when the clusters energized to create the desired colored shapes on the screen of the display.

Each traffic light has a certain shape, the red signal light will appear as a rectangular red color on the screen of the display (panel) preferably with the same dimensions of the screen (12×9) inches, the yellow signal light will appear as vertical yellow stripes with preferable width of (1.5-2) inches and dark (black) vertical stripes with preferable same width of the yellow stripes, the yellow and the black stripes will cover the full area of the screen display, the green signal light will appear as a green light circle in the center of the screen of the display with a preferable diameter of (9) inches, the rest area of the screen will appear in black,

therefore, the drivers will recognize the red light when the display is fully lighted with red light, moreover, they will recognize the yellow signal light when the display is striped with yellow light and they will recognize the green signal light when the display is lighted by a green circle.

These shapes were chosen carefully to help the color blind drivers to distinguish the fully lighted screen from the stripe lighted screen and from the circularly lighted screen, the dimensions of these shapes were chosen to provide the best visibility to the drivers.

Additionally, the arrows will appear as lighted arrows on a dark (black) background, the green arrow will light in green and the yellow arrow will light in striped yellow,

Furthermore, in some applications while flashing traffic light is adopted, the flashing stripes of the yellow light will be easily distinguishable from the flashing full screen red light, also in some applications around schools, the display (panel) can provide the digital message when vehicles approach school zones, the digital message alert the drivers to the desired speed of their vehicles which usually (20 mph) around schools, moreover, flashing signal lights are adopted in the school zones, thus, one single programmable display will be efficient to display the desired speed and the flashing light consecutively.

Therefore, the programmable colored LED display will be efficient to provide the traffic signal lights, the digital desired speed messages, the warning flashing lights, the text messages and the pedestrian alerting images alike.

### Therefore;

It is an object of the present invention to provide a programmable multi color Light Emitting Diods (LEDs) display (panel) comprising a matrix of LED clusters, each cluster comprising at least three different colored LEDs, red LED, green LED and blue or yellow LED, to provide the colored lights required to control the traffic signal lights; a red light, a yellow light and a green light.

It is another object of the present invention to provide a rectangular LED programmable display with preferred dimensions of (12×9) inches to provide high visibility colors and shapes of the designed traffic lights and symbols.

It is another object of the present invention to provide a programmable LED display controlled by a microprocessor or a traffic computer to display the traffic lights coupled with the desired duration of each signal light.

It is another object of the present invention to provide all the electronic components such as; microchips, memory, microprocessor, the operating program and the other accessories needed to operate the LED display with a high efficiency.

It is another object of the present invention to provide a rectangular housing comprising the LED display and all the other parts of the device, this housing should have the members needed to mount it into the traffic poles or cables and should have enough weight to withstand the wind.

It is an object of the present invention to provide a programmable multi color LED display to replace the conevtional vertical array of the incandescent rounds of light wherein the three traffic lights; red, yellow and green will be displayed consecutively.

It is an object of the present invention to display the red light on the full area of the screen of the programmable LED display.

It is an object of the present invention to display the yellow light in a form of vertical yellow stripes with preferable width of (1.5-2) inches, also other patterns of yellow light is welcomed too.

It is an object of the present invention to display the green light in a form of a green circle in the center of the screen of the LED display with preferable diameter of (9) inches.

It is an object of the present invention to provide one single programmable LED display (panel) to display the three traffic lights one at a time (consecutively) on the same screen of the programmable LED display coupled with their designed durations.

It is an object of the present invention to provide one single LED display to replace the rounds of the arrow signal lights at an intersection.

It is another object of the present invention to provide a programmable LED display to display a green light arrow and a yellow light arrow with blank parts in its body to be easily distinguishable by color blind drivers, other patterns of the arrow yellow light is welcomed too.

It is another object of the present invention to provide a programmable LED display to replace the conventional pedestrian (walk-DONT WALK) box or the conventional (hand-figur-walking-figure) box.

It is an object of the present invention to provide a programmable LED display (panel) capable of displaying the desired traffic symbols such as the hospital symbol (H) coupled with a blinking screen showing how many miles away from the hospital and its direction.

It is an object of the present invention to provide a programmable LED display capable of displaying text messages such as (WALK-DONT WALK), also capable of displaying visible digital messages such as the speed limit around schools coupled with blinking warning screen to alert the drivers.

It is a further object of the present invention to provide a programmable LED display capable of displaying traffic images such as the pedestrians hand-figure and a walking-figuer images.

It is a further object of the present invention to provide a method and a system of using the present invention to enhance the visibility of the traffic lights and easily distinguishable for color blind drivers.

It is a last object of the present invention to have a less expensive,high efficient,less power consumption and easy to mount programmable colored LED display (panel) to replace the conventional traffic light.

### BRIEF DESCRIPTION OF THE DRAWINGS

FIG. 1a: shows a programmable multi color LED display (panel) 10 according to the embodiment of the present invention;

FIG. 1b: shows a close up part of the screen 50 of the programmable LED display embedding a matrix of multi color LED clusters 60 according to the embodiment of the present invention;

FIG. 2: shows a programmable LED display 10 during the three phases of the traffic signal lights;

FIG. 2a: shows the LED display 10 while the traffic light is red,

FIG. 2b: shows the LED display 10 while the traffic light is yellow,

FIG. 2c: shows the LED display 10 while the traffic light is green.

FIG. 3: shows the LED display 10 during the phases of the arrow signal lights;

FIG. 3a: shows the LED display 10 while the arrow signal light is green,

FIG. 3b: shows the LED display 10 while the arrow signal light is yellow.

FIG. 4a: shows an example of using the conventional traffic signal lights in a double-lane street intersection.

FIG. 4b: shows an example of using the new programmable LED display 10 in a double-lane intersection, each LED display replaces a single vertical arrangement of three of conventional rounds of traffic signal lights of FIG. 4a.

FIG. 5: shows examples of using the LED display 10 in some applications such as;

FIG. 5a: using the LED display 10 to display the desired speed limit around the school zones;

FIG. 5b: using the LED display 10 to display the symbol H of a near by hospital;

FIGS. 5c,D,E,F: when using the LED display 10 to display the pedestrian text messages and the images.

FIG. 6: shows the LED display 10 according to the embodiment of the present invention and the rain guard 90 which protects the the screen of the display against the rain, snow and other weather factors, also the guard provides shade to the screen of the display.

### DETAILED DESCRIPTION OF THE PRESENT INVENTION

The present invention addresses a new design of a programmable multi color Light Emitting Diods (LEDs), which is designed to replace the conventional traffic signal lights.

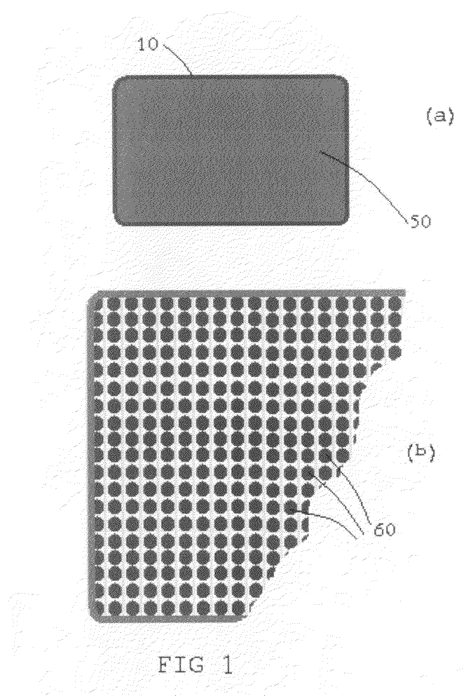

FIG. 1 shows the screen 50 of a programmable multi color LED rectangular display (panel) 10 with preferable dimensions of (12×9) inches, the LED display 10 comprising a matrix of LED clusters 60 arranged tightly to provide a high performance colored display as show in FIG. 1b, each cluster comprising at least three colored LEDs, red, green and blue or yellow LED, to have a display capable of producing at least three color lights, red, green and yellow, the matrix of clusters 60 is not limited to a certain arrangement of the LEDs, the matrix of clusters as shown in FIG. 1b is just an example of how the clusters 60 are arranged tightly to provide a high quality colored screen 50, the LED display 10 is controlled by a processor or a traffic computer coupled with the operating program to provide the colored shapes and images on the screen 50 of the LED display 10, the LED display 10 has a rectangular housing which has enough weight to withstand the wind if it is hung from a cable at an intersection, furthermore, this housing comprising all the electronic components such as the LEDs matrix, microchips, microprocessors, memory, . . . etc., and the other accessories needed to form the device (LED display 10), also the housing of the LED display should have all the members needed to mount it on a pole or a cable.

In the new embodiment of the present invention, the LED display 10 will provide the three traffic signal lights; red, green and yellow light on the same screen 50 of the same LED display 10 consecutively and each signal light has a specific duration,

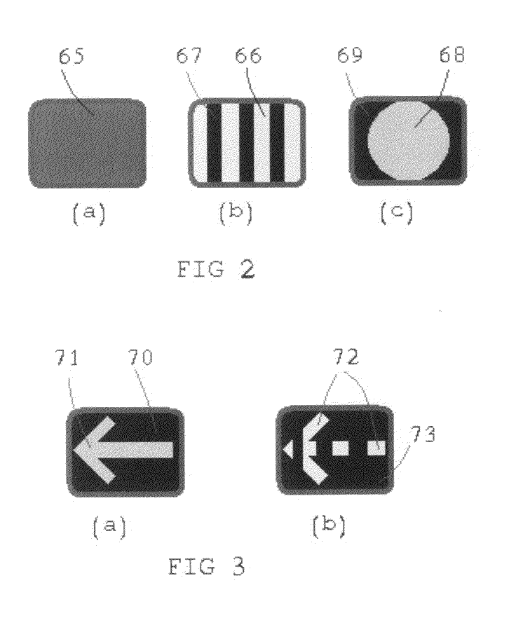

Furthermore, FIG. 2 shows the LED display 10 displaying the three traffic lights consecutively when the traffic signal is red, the screen 50 of the LED display 10 will be fully lighted with red light 65, the lighted area will have the same dimensions of the screen 50 in a form of a rectangular preferably (12×9) inches as shown in FIG. 2a.

when the traffic signal is green, the screen 50 of the LED display 10 will have a fully lighted green circle 68 which has a preferable diameter of (9) inches in the center of the screen 50, while the rest area 69 of the screen 50 will remain dark(black) as shown in FIG. 2c.
when the traffic signal is yellow, the screen 50 of the LED display 10 will have vertical fully lighted yellow stripes 66 with preferable width of (1.5-2) inches and a length of (9) inches, while the rest areas of the screen 50 will remain dark(black), the remaining areas will be dark(black) stripes of a preferable width of (1.5-2) inches and a length of (9)inches as shown in FIG. 2b,
note: the yellow light could have other patterns if preferred,

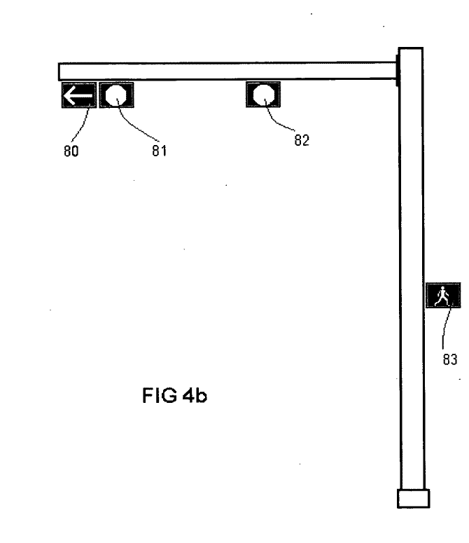

Furthermore, for the best use of the present LED display 10, a preferable one single display (panel) is needed to provide the three traffic signal lights only, while it is preferable to display the arrow signal lights in a seperate LED display 10 as shown in the example of FIG. 4b,

the foregoing descriptions of the present invention shows that the traffic computer or the processor will control the LED display 10 through the operating program to run the programmed traffic lights and the other shapes and messages on the screen 50.

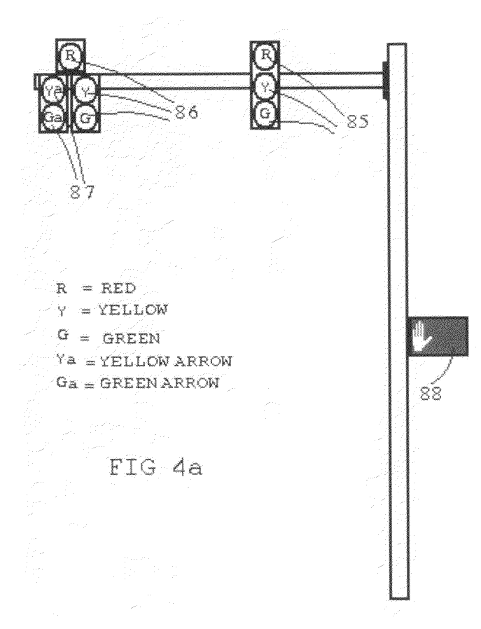

Therefore, as we see in FIG. 3, a seperate LED display 10 displaying the green arrow 71, the green arrow 71 is fully lighted with green light and the remaining area 70 of the screen 50 is dark(black) as shown in FIG. 3a, also the yellow arrow 72 is designed in a preferable shape of having blank areas in its body, the yellow parts 72 of its body is fully lighted with yellow light while the blank areas of the arrow and the rest area 73 of the screen 50 is dark(black) as shown in FIG. 3b.

The processor or the traffic computer will control the programmable LED display 10 to display the three traffic signal lights consecutively and controls the arrow signal lights consecutively as well, the processor or the traffic computer will control the duration of each signal light also.

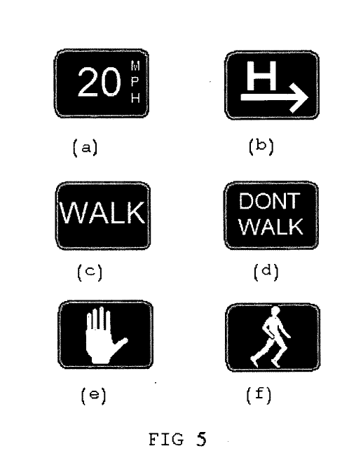

FIG. 5, shows few samples of using the programmable LED display 10 in some applications as shown in the following cases; as shown in FIG. 5a, the LED display 10 can provide the speed limit (20 mph) for example around the school zones, also the same LED display 10 can provide a blinking screen with the speed limit message consecutively to warn the drivers of the speed limit around school zones,

As shown in FIG. 5b, the programmable LED display 10 can provide the hospital's symbol (H) and the direction to the hospital, also the LED display 10 can provide the distance to the hospital in miles on the same blinking screen with the symbol (H).

As shown in FIGS. 5(c,d), the LED display 10 can provide text messages for pedestrians, the LED display 10 can display the text (WALK) lighted on the screen 50 and the text (DONT WALK) lighted on the same screen 50 consecutively with the programmable duration.

As shown in FIGS. 5(e,f), the programmable LED display 10 can display the pedestrian's images on its screen 50 consecutively as well.

The foregoing description of a preferred embodiment of the present invention shows how a programmable multi color Light Emitting Diods (LEDs) display (panel) 10 is suitable to display the desired colored traffic lights coupled with their designed shapes, the desired text messages and the desired traffic images coupled with their duration consecutively.

Furthermore, a preferred embodiment of the present invention is not limited to certain shapes or dimensions, the embodiment comprising a programmable LED display 10 which can be made of any suitable materials, it can provide a new update of the conventional traffic lights and can be a standard panel to provide text messages or images to the drivers and the pedestrians.

FIG. 4a, shows an example of using the conventional traffic lights in a two-lane street intersection, both lanes controled by two vertical sets of rounds of incandescent lights 85, 86 and a set of arrow signal rounds 87, from this example we will see how bulky and heavy the conventional traffic lights look, the light rounds 85 provide the red, yellow and green signal lights, the red round on top, yellow round in the middle and the green round in the bottom,

the rounds 86 provide a red round on top, a yellow round in the middle and a green round in the bottom,

Furthermore, the signal rounds 87 show the arrow yellow round on top and the arrow green round in the bottom, the pedestrian's images are shown on the box 88, the box 88 generally illuminated by incandescent bulb, one half of the box 88 shows a hand-figure to guide the pedestrians not to cross the intersection and the image of a walking-figure on the other half of the box 88 to allow the pedestrians to cross the intersection, in some cases the box 88 contains the text messages (WALK) and (DONT WALK) to guide the pedestrians to cross or not to cross the intersection.

FIG. 4a illustrates the three signal lights and their positions on the vertical array, while applying the new programmable LED display (panel) 10 on the same example of FIG. 4a as shown in FIG. 4b,

we will see that one single LED display 10 replaced a vertical set of the conventional traffic light, the programmable LED display 82 replaced the vertical set of incandescent signal rounds 85, and the programmable LED display 81 replaced the vertical set of incandescent signal rounds 86, also the programmable LED display 80 replaced the vertical set of incandescent signal rounds 87, moreover, the LED display 83 replaced the box 88,

FIG. 4b shows how neat applying the new programmable LED display in most of traffic applications.

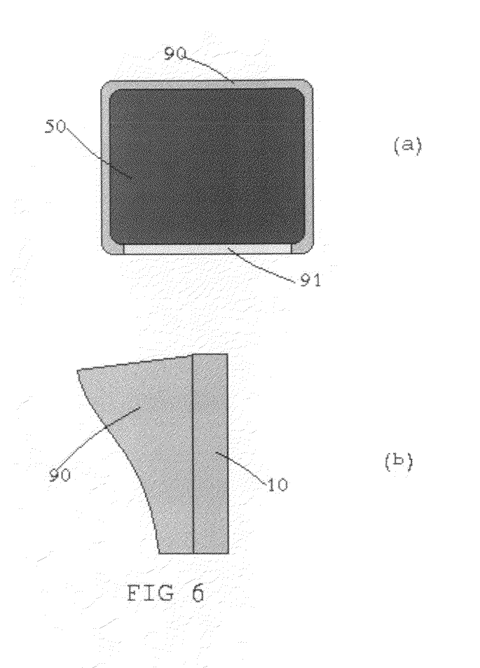

FIG. 6a, shows a general look of the programmable LED display 10 from the front, the rain guard 90 attached to the housing of the LED display 10 and extended forward in three sides to give shade and to protect the LED display 10 from the weather factors, the bottom side 91 of the housing is not extended forward.

FIG. 6b shows a side view of the LED display 10, also it shows the rain guard 90 which protects the screen 50 of the LED display 10 from the rain, snow and other weather factors, furthermore the guard 90 gives some shade to the screen 50 to enhance the visibility of the signal lights.

Therefore, a programmable multi color LED display (panel) invention is overall very efficient, less power consumption, less expensive, neat and easy to install, and is designed to provide easily distinguishable colored; signal lights, texts, images, . . . etc. and controlled by a traffic program.

1- A programmable multi color Light Emitting Diods (LED) display (panel) comprising:
A rectangular LED display with preferred dimensions of (12×9)inches, wherein a matrix of LED clusters embedded into the rectangular housing of the display,each LED cluster comprising at least three colored LEDs, red, green and blue or yellow LED.

2- The programmable LED display according to claim 1 wherein said clusters controlled by a computer traffic or a processor and energized to emit the desired light to create the desired images and shapes according the operating program of the LED display.

3- The programmable LED display according to claim 1 wherein the face (screen) of the LED display comprising a matrix of multi color LEDs, and has preferable dimensions of (12×9)inches and embedded into the housing of the LED display.

4- The programmable LED display according to claim 2 wherein the matrix of the LEDs provides three traffic signal lights consecutively; red light, green light and yellow light to control the traffic at an intersection, wherein the red light has a rectangular shape with preferable dimensions of (12×9) inches and the green light has a circular shape with a preferable diameter of (9)inches in the center of the screen of the LED display,
furthermore, the yellow light has the shape of vertical yellow stripes with a preferable width of (1.5-2)inches and a preferable length of (9) inches,
moreover, the yellow signal light could have other desired patterns according the operating program.

5- The programmable LED display according to claim 2 wherein the matrix of the LEDs provides two traffic arrow signal lights consecutively; a green arrow light and a yellow arrow light wherein blank areas in its body.

6- The programmable LED display according to claim 2 wherein the matrix of the LEDs provides a display capable of displaying colored traffic images and text messages such as the hand-figure, walking-figure, the speed limits around schools, . . . etc.

7- The programmable LED display according to claim 4 wherein the matrix of the LEDs controlled by a processor or a traffic computer to provide programmable traffic lights consecutively with the desired duration, also to provide the desired traffic images and the desired traffic text messages according the operating program.

8- The programmable LED display according to claim 1 wherein the rectangular housing comprising all the electronic components of the LED display such as the LEDs, microchips, memory, processor, . . . etc.

9- The programmable LED display according to claim 1 wherein the rectangular housing has all the members needed to mount it on a cable or a pole at an intersection.

10- The programmable LED display according to claim 1 wherein the rectangular housing has enough weight to withstand the wind while its hanging on a cable at an intersection.

11- The programmable LED display according to claim 1 wherein the rain gaurd is attached to the front of the housing and extended forward from three sides; the top and the two lateral sides to protect the screen of the LED display from the weather factors such as rain, snow, . . . etc. and provides shade to the screen to enhance the visibility of the traffic lights.

12- The shape of a rectangular red light as a symbol of a STOP signal light.

13- The shape of vertically striped yellow light on a dark background as a symbol of CAUTION (alerting) signal light.

14- The shape of a circular green light on a dark background as a symbol of PASSING signal light.

15- The method and the operating program of of displaying multiple images or shapes or text messages on the same screen of the LED display.

16- The method and the example of using the LED display to display the traffic symbols and more particularly the hospital's symbol H and its direction and the distance in miles to this hospital on the screen of the same LED display.

17- A method and a system of the best configurations to use the LED display to replace the conventional vertical array of round traffic lights such as assigning a seperate LED display to replace a single vertical set of the conventional traffic lights and a seperate LED display to control the turning at an intersection.
